(19) United States
(12) Patent Application Publication
(10) Pub. No.: US 2026/0179654 A1
(43) Pub. Date: Jun. 25, 2026

(54) METHOD FOR EDITING AUDIO EFFECT, DEVICE, AND STORAGE MEDIUM

(71) Applicants: Lemon Inc., Grand Cayman (KY); Beijing Zitiao Network Technology Co., Ltd., Beijing (CN)

(72) Inventors: Chenyu SUN, Los Angeles, CA (US); Yuan XU, Beijing (CN); Ruifeng MA, Beijing (CN); Tao XIONG, Beijing (CN); Hao HUANG, Beijing (CN); Xuye CAI, Beijing (CN); Yifei BI, Beijing (CN)

(21) Appl. No.: 19/127,001

(22) PCT Filed: Nov. 8, 2023
(86) PCT No.: PCT/CN2023/130425

§ 371 Date: May 2, 2025

(30) Foreign Application Priority Data
Nov. 9, 2022 (CN) 202211400738.8

(51) Int. Cl. G11B 27/031; G10L 15/22; G10L 21/00

(52) U.S. Cl. CPC G11B 27/031; G10L 15/22; G10L 21/00

(57) ABSTRACT

Embodiments of the present disclosure provide a method and an apparatus for editing an audio effect, a device, and a storage medium. The method includes: creating an audio source control, an audio source controlling control, an audio control, and an audio post-processing control in an audio editing interface based on a first creation operation triggered by a user; connecting an output port of the audio source control to an input port of the audio source controlling control, connecting an output port of the audio source controlling control to an input port of the audio control, and connecting an output port of the audio control to an input port of the audio post-processing control; and controlling an original audio stream to sequentially flow from the audio source control through the audio source controlling control, the audio control, and the audio post-processing control, to obtain target effect audio.

The present application claims the priority to Chinese Patent Application No. 202211400738.8, filed on Nov. 9, 2022, the entire disclosure of which is incorporated herein by reference as portion of the present application.

### TECHNICAL FIELD

Embodiments of the present disclosure relate to a method and an apparatus for editing an audio effect, a device, and a storage medium.

### BACKGROUND

Traditional audio editing software usually edits audio through audio tracks, which has a high learning curve, a complex configuration, and is difficult to integrate with effect editing scenarios.

### SUMMARY

The method for editing an audio effect, a device, and a storage medium provided by the embodiments of the present disclosure utilize a graphical approach to implement audio effect editing, which can reduce the complexity of editing the audio effect.

In a first aspect, the embodiments of the present disclosure provide a method for editing an audio effect, including:
creating an audio source control, an audio source controlling control, an audio control, and an audio post-processing control in an audio editing interface based on a first creation operation triggered by a user, in which the audio source control includes at least one of a local audio source control and a microphone audio source control, the audio control includes at least one of an audio effect control and an audio detection control, and the audio post-processing control includes at least one of an audio playback control and an audio recording control;
connecting an output port of the audio source control to an input port of the audio source controlling control, connecting an output port of the audio source controlling control to an input port of the audio control, and connecting an output port of the audio control to an input port of the audio post-processing control; and
controlling an original audio stream to sequentially flow from the audio source control through the audio source controlling control, the audio control, and the audio post-processing control, to obtain target effect audio.

In a second aspect, the embodiments of the present disclosure further provide an apparatus for editing an audio effect, including:
a first control creation module, configured to create an audio source control, an audio source controlling control, an audio control, and an audio post-processing control in an audio editing interface based on a first creation operation triggered by a user, in which the audio source control includes at least one of a local audio source control and a microphone audio source control, the audio control includes at least one of an audio effect control and an audio detection control, and the audio post-processing control includes at least one of an audio playback control and an audio recording control;
a control connection module, configured to connect an output port of the audio source control to an input port of the audio source controlling control, connect an output port of the audio source controlling control to an input port of the audio control, and connect an output port of the audio control to an input port of the audio post-processing control; and
a target effect audio acquisition module, configured to control an original audio stream to sequentially flow from the audio source control through the audio source controlling control, the audio control, and the audio post-processing control, to obtain target effect audio.

In a third aspect, the embodiments of the present disclosure further provide an electronic device, including:
one or more processors; and
a storage apparatus configured to store one or more programs;
when the one or more programs are executed by the one or more processors, the one or more processors implement the method for editing an audio effect according to the embodiments of the present disclosure.

In a fourth aspect, the embodiments of the present disclosure further provide a storage medium including computer-executable instructions, and the computer-executable instructions, when executed by a computer processor, perform the method for editing an audio effect according to the embodiments of the present disclosure.

### BRIEF DESCRIPTION OF DRAWINGS

In conjunction with the drawings and with reference to the following detailed description, the above-mentioned and other features, advantages, and aspects of the various embodiments of the present disclosure will become more apparent. Throughout the drawings, the same or similar reference numerals denote the same or similar elements. It should be understood that the drawings are illustrative and the components and elements are not necessarily drawn to scale.

FIG. 1 is a schematic flow diagram of a method for editing an audio effect provided by the embodiments of the present disclosure;

FIG. 2a is an exemplary diagram of an audio effect editing graph provided by the embodiments of the present disclosure;

FIG. 2b is an exemplary diagram of an audio effect editing graph provided by the embodiments of the present disclosure;

FIG. 2c is an exemplary diagram of an audio effect editing graph provided by the embodiments of the present disclosure;

FIG. 3 is an exemplary diagram of an audio effect editing graph provided by the embodiments of the present disclosure;

FIG. 4 is an exemplary diagram of an audio effect editing graph provided by the embodiments of the present disclosure;

FIG. 5 is a schematic structural diagram of an apparatus for editing an audio effect provided by the embodiments of the present disclosure; and

FIG. 6 is a schematic structural diagram of an electronic device provided by the embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message.

As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

Furthermore, it may be understood that the data involved in the technical solutions (including but not limited to the data itself, data acquisition or use) should comply with the requirements of corresponding laws, regulations and relevant provisions.

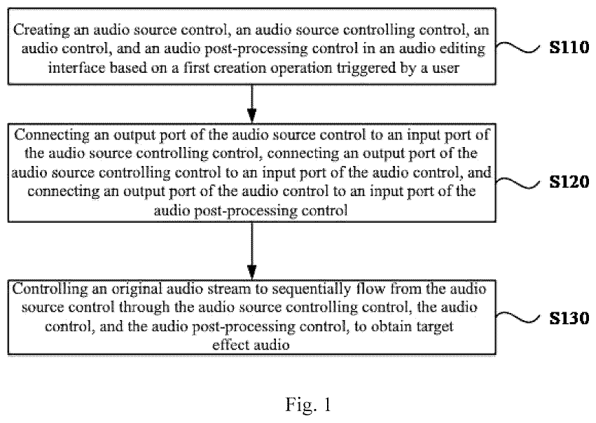

FIG. 1 is a schematic flow diagram of a method for editing an audio effect provided by the embodiments of the present disclosure, and the embodiment may be applied to the case where editing of an audio effect is realized in a graphical approach. The method may be performed by an apparatus for editing an audio effect, and the apparatus may be composed of hardware and/or software and may be generally integrated in a device having an audio effect editing function, for example, the device may be an electronic device such as a server, a mobile terminal or a server cluster. As shown in FIG. 1, the method includes the following steps.

In S110, creating an audio source control, an audio source controlling control, an audio control, and an audio post-processing control in an audio editing interface based on a first creation operation triggered by a user.

The audio source control includes at least one of a local audio source control and a microphone audio source control; the audio control includes at least one of an audio effect control and an audio detection control; and the audio post-processing control includes at least one of an audio playback control and an audio recording control.

For example, the audio source control is used to input audio data as an audio stream. The local audio source control may input local audio data as an audio stream, and the microphone audio source control is used to turn on a terminal microphone and input the audio stream captured by the microphone in real time.

An audio effect control may be understood as a control for performing effect processing on an audio signal, and the audio effect control may include a filtering control, a volume limit control, a volume adjustment control, a delay control, a reverberation control, a tremolo control, a volume amplification control, an audio gain control, and an audio mixing control. The filtering control may be understood as a filter, and may include a high-pass filter or a low-pass filter. The volume limit control is used to limit the volume of the audio signal. When the audio signal is mixed or the volume is increased, the volume may exceed 1.0, which may cause the audio quality to be damaged, and therefore the volume needs to be limited. The function of the volume limit control is to limit the volume of the audio signal to a set threshold value. The volume adjustment control is used to automatically adjust the volume of audio signal. In response to the volume being too large, the volume is decreased, and in response to the volume being too small, the volume is increased. The delay control may be understood to delay an audio signal, known as an echo. The reverberation control may be used to create a sense of distance and a sense of space for the audio signal. The tremolo control may be used to perform tremolo effect processing on the audio signal. The volume amplification control may be used to increase the volume of the audio signal to simulate the effect of a large loudspeaker. The audio gain control may be used to perform gain process on the audio signal. The audio mixing control may be used to mix a plurality of audio signals.

The audio detection control is used to detect various parameters in the audio signal. The audio detection control may include an accent detection control, a volume detection control, a pitch detection control, a rhythm detection control, and a spectrum detection control. That is, the audio detection control detects audio information of the input audio stream of the current frame, and the audio information may include information such as accent, volume, pitch, rhythm and spectrum. The accent detection control is used to detect accents in the audio signal, and output the amplitude of the nearest rhythm point of the current audio frame. The volume detection control is used to detect the volume of the audio signal, and output the volume of the current audio frame. The pitch detection control is used to detect the pitch of the audio signal and output the pitch of the current audio frame, and the pitch detection control supports monophonic input, otherwise the detection result may be inaccurate. The rhythm detection control is used to detect the rhythm intensity of the audio signal and output the rhythm intensity of the current audio frame; and the rhythm intensity includes strong (1), weak (2), medium-strong (3), medium-weak (4). The spectrum detection control is used to detect the spectrum of the audio signal, and output the average value of energy of the spectrum segment corresponding to the current audio frame.

The audio playback control is used to play the input audio stream, similar to the function of a speaker. The audio recording control is used to record the audio signal. The audio recording control may be an internal audio recording control or an external audio recording control. The internal audio recording control may be used to store the transmitted audio stream, and the external audio recording control may be used to record the audio played externally.

In the present embodiment, the audio source control, the audio source controlling control, the audio control, and the audio post-processing control are pre-designed by developers and integrated into the audio effect editing tool. When effect editing on audio or making an audio effect package is required, users can create the audio source control, the audio source controlling control, the audio control, and the audio post-processing control in the audio editing interface of the audio effect editing tool according to effect requirements. The creation method may involve locating the required controls in a control library and dragging the controls into the audio editing interface. In the present embodiment, there is no limitation on the type and quantity of the created audio effect control(s) and/or audio detection control(s). Users can add the audio effect control(s) and/or audio detection control(s) freely according to their effect requirements.

In S120, connecting an output port of the audio source control to an input port of the audio source controlling control, connecting an output port of the audio source controlling control to an input port of the audio control, and connecting an output port of the audio control to an input port of the audio post-processing control.

In the present embodiment, the output port of the audio source control is an audio output port; the input port of the audio source controlling control is an audio input port; the output port of the audio source controlling control is an audio output port; the input port of the audio control includes an audio input port and a control input port, and the output port of the audio control includes an audio output port and a control output port; and the input port of the audio post-processing control includes an audio input port.

Specifically, the audio output port of the audio source control is connected to the audio input port of the audio source controlling control; the audio output port of the audio source controlling control is connected to the audio input port of the audio control; and the audio output port of the audio control is connected to the audio input port of the audio post-processing control such that an audio stream is transmitted in various controls.

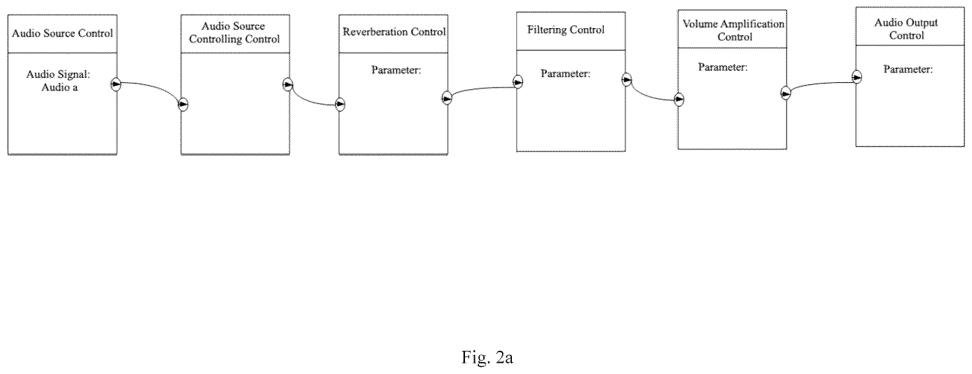

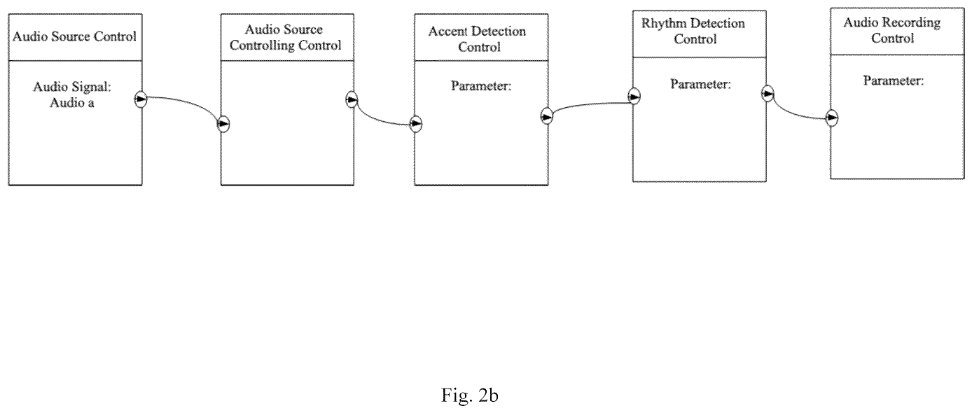

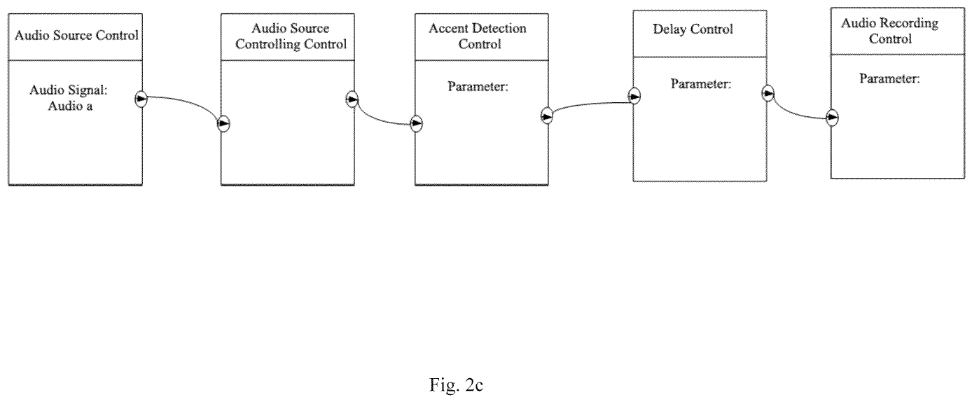

In the present embodiment, assuming that the audio control is a plurality of audio effect controls, firstly the connection order of the plurality of audio effect controls is determined, the plurality of audio effect controls are connected according to the connection order in a manner that the audio output port is connected to the audio output port, and then the audio output port of the audio source control is connected to the audio input port of the audio source controlling control; the audio output port of the audio source controlling control is connected to an audio input port of an audio effect control at the first position; and the audio output port of the audio effect control at the end position is connected to the audio input port of the audio post-processing control. Exemplarily, FIG. 2a is an exemplary diagram of an audio effect editing graph provided by the embodiments of the present disclosure. As shown in FIG. 2a, the audio control includes a reverberation control, a filtering control, and a volume amplification control, and the audio post-processing control is an audio playback control, then an audio stream of audio a sequentially flows through the audio source control, the audio source controlling control, the reverberation control, the filtering control, the volume amplification control, and the audio playback control.

In the present embodiment, assuming that the audio control is a plurality of audio detection controls, firstly the connection order of the plurality of audio detection controls is determined, the plurality of audio detection controls are connected according to the connection order in a manner that the audio output port is connected to the audio output port, and then the audio output port of the audio source control is connected to the audio input port of the audio source controlling control; the audio output port of the audio source controlling control is connected to an audio input port of an audio detection control at the first position; and the audio output port of the audio detection control at the end position is connected to the audio input port of the audio post-processing control. Exemplarily, FIG. 2b is an exemplary diagram of an audio effect editing graph provided by the embodiments of the present disclosure. As shown in FIG. 2b, the audio control includes an accent detection control and a rhythm detection control, and the audio post-processing control is an audio recording control, then the audio stream of audio a sequentially flows through the audio source control, the audio source controlling control, the accent detection control, the rhythm detection control, and the audio recording control.

In the present embodiment, assuming that the audio control includes at least one audio effect control and at least one audio detection control, firstly the connection order of the at least one audio effect control and the at least one audio detection control is determined, and the at least one audio effect control and the at least one audio detection control are connected according to the connection order in a manner that the audio output port is connected to the audio output port, and then the audio output port of the audio source control is connected to the audio input port of the audio source controlling control; the audio output port of the audio source controlling control is connected to the audio input port of an audio control at the first position; and the audio output port of the audio control at the end position is connected to the audio input port of the audio post-processing control. Exemplarily, FIG. 2c is an exemplary diagram of an audio effect editing graph provided by the embodiments of the present disclosure. As shown in FIG. 2c, the audio control includes an accent detection control and a delay control, and the audio post-processing control is an audio recording control, then the audio stream of audio a sequentially flows through the audio source control, the audio source controlling control, the accent detection control, the delay control, and the audio recording control.

Optionally, the audio source controlling control is provided with a control parameter configuration window for receiving a control parameter input by the user through the control parameter configuration window, to control the original audio stream according to the control parameter.

For example, the control parameter may include a playback condition of the audio stream, a pause condition of the audio stream, the quantity of cyclic playbacks of the audio stream, etc. Here, the playback condition and the pause condition may be preset and selected by the user. As an example, the playback condition may be a certain trigger operation of the user being detected, and the trigger operation may be a user posing a predetermined gesture (e.g., making a “heart” gesture, opening mouth, etc.), touching the screen in a predetermined manner (e.g., drawing an S-shaped curve, an L-shaped curve, etc.), or detecting a predetermined user speech (e.g., the speech is “start playback”, etc.). The pause condition is similar to the playback condition and will not be described again here. The quantity of cyclic playbacks may be understood as the quantity of cyclic playbacks of the input audio stream. In the present embodiment, the flexibility of audio effect processing is enabled by setting control parameters in the audio source controlling controls to control the original audio stream.

Optionally, the audio detection control comprises a speech recognition control, a speech keyword recognition control, and a target object recognition control.

For example, the speech recognition control is used to identify semantic information of speech in the original audio stream; the speech keyword recognition control is used to identify keywords of the speech in the original audio stream; and the target object recognition control is used to identify a target object of the speech in the original audio stream.

The speech recognition control may be integrated with a semantic recognition algorithm, and after the audio stream is input into the speech recognition control, the speech recognition control invokes the semantic recognition algorithm to recognize the semantic information of the speech in the original audio stream. Specifically, after recognizing the semantic information of the speech in the original audio stream, a corresponding effect may be performed based on the semantic information. For example, the semantic information may be displayed in the form of subtitles.

The speech keyword recognition control may be integrated with a keyword recognition algorithm, and after the audio stream is input into the speech keyword recognition control, the speech keyword recognition control invokes the keyword recognition algorithm to recognize the keyword of the speech in the original audio stream. Specifically, after recognizing the keyword of the speech in the original audio stream, a corresponding effect may be performed based on the keyword. For example, parameters required for audio effects or parameters required for audio detection control are generated based on the keyword.

Here, the target object may be a musical instrument category or the like contained within the audio. The target object recognition control may be integrated with a target object recognition algorithm, and after the audio stream is input into the target object recognition control, the target object recognition control invokes the target object recognition algorithm to recognize the target object of the speech in the original audio stream. Specifically, after recognizing the target object of the speech in the original audio stream, a corresponding effect may be performed based on the target object. Exemplarily, assuming that the target object is a drum set, the identified drum set is used to decrease or increase the detection threshold value in the accent detection control. In the present embodiment, the diversity of audio effect editing can be enhanced by identifying semantic information, keywords and target objects in the audio stream.

Optionally, at least one of the audio effect control and the audio detection control is provided with a processing parameter configuration window for receiving a processing parameter input by the user through the processing parameter configuration window, to process the input audio stream according to the processing parameter; or a parameter generation control is created in the audio editing interface based on a second creation operation triggered by the user, and the parameter generation control is connected to at least one of the audio effect control and the audio detection control; and at least one of the audio effect control and the audio detection control receives a processing parameter generated by the parameter generation control to process an input audio stream according to the processing parameter.

For example, the processing parameter of the audio effect control is an effect parameter. For example, the effect parameter of the filtering control may be a filtering parameter, the effect parameter of the volume limit control may be a volume limiting threshold value, the effect parameter of the volume adjustment control may be an adjustment amount, the effect parameter of the delay control may be a delay duration, the effect parameter of the reverberation control may be a reverberation ratio, the effect parameter of the tremolo control may be a tremolo amplitude, and the effect parameter of the volume amplification control may be an amplification factor. The processing parameter of the audio detection control is a detection parameter, for example, the detection parameter of the accent detection control is an accent threshold value, the detection parameter of the volume detection control is a volume threshold value, the detection parameter of the pitch detection control is a pitch threshold value, the detection parameter of the rhythm detection control is a rhythm threshold value, and the detection parameter of the spectrum detection control is a frequency range.

In the present embodiment, the user inputs the processing parameters through the configuration window to process the input audio stream according to the processing parameters. The processing parameters set by the method remain unchanged during the whole audio playing process, which can ensure the stability of effect processing.

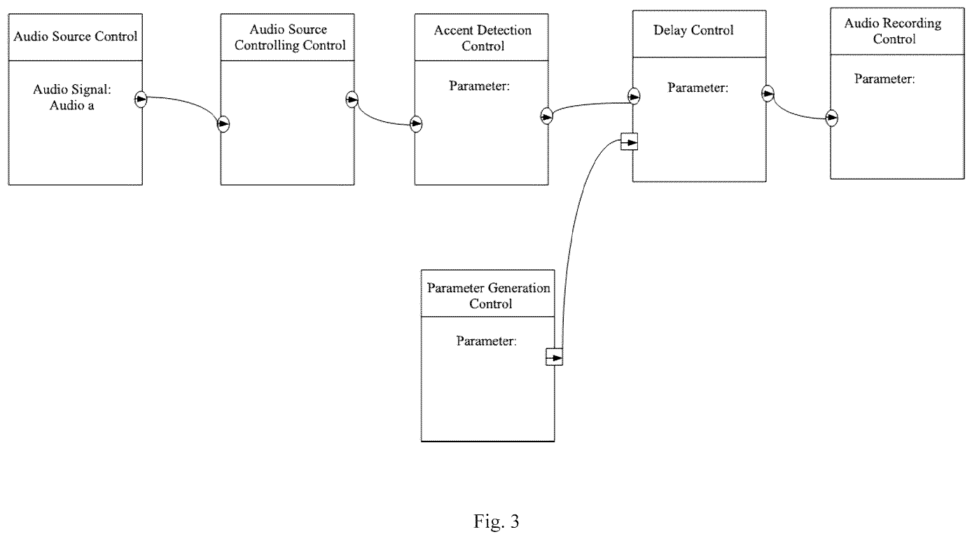

The parameter generation control is used to generate a processing parameter and input the processing parameter to at least one of the audio effect control and the audio detection control. In the present embodiment, a control output port of the parameter generation control is connected to a control input port of at least one of the audio effect control and the audio detection control, that is, a processing parameter, rather than an audio stream, is output between the parameter generation control and the audio control. Exemplarily, FIG. 3 is an exemplary diagram of an audio effect editing graph provided by the embodiments of the present disclosure. As shown in FIG. 3, the processing parameter generated by the parameter generation control is input into the delay control as the delay duration of the delay control, so that the delay control delays the audio stream based on the delay duration. In the present embodiment, at least one of the audio effect control and the audio detection control processes the input audio stream based on the processing parameter generated by the parameter generation control, so that the diversity of the effect processing may be enhanced.

Optionally, the parameter generation control is configured by connecting at least one operation control according to a set operation logic, and an input parameter of the at least one operation control is adjusted by the user.

The operation control may be a control for performing a certain mathematical operation, such as addition, multiplication, setting function operations (e.g., cosine function, sine function, exponential function, etc.). In the present embodiment, at least one operation control is connected according to the set operation logic, so that the parameter generation control constructed has a calculation capability of the set mathematical operation logic. Exemplarily, the input parameters include a, b and c, and the operation logic is (sina+b)*c. Then firstly, operation controls required by the operation logic are created, then the operation controls are connected according to the operation logic, and finally the specific values of a, b and c are input, thereby generating a value. In the present embodiment, the three values a, b and c may be updated by the user at any time during the whole audio playing process, so that the generated processing parameters are also different, and the subsequent effect processing or audio detection results are also correspondingly different. In the present embodiment, by adjusting the processing parameters in real time, not only the diversity of the audio effect processing process may be enhanced, but also the flexibility may be enhanced.

In S130, controlling an original audio stream to sequentially flow from the audio source control through the audio source controlling control, the audio control, and the audio post-processing control, to obtain target effect audio.

Specifically, after connecting the audio source control, the audio source controlling control, the audio control, and the audio post-processing control, the input audio stream sequentially flows from the audio source control through the audio source controlling control, the audio control, and the audio post-processing control, and after the audio stream enters a corresponding control, the control executes a corresponding function on the audio stream, and finally the target effect audio is generated.

Optionally, an audio source placeholder control is created in the audio editing interface based on a third creation operation triggered by the user; and the audio source placeholder control is connected between the audio source controlling control and the audio control. The audio source placeholder control is used for inputting a far-end audio stream.

In the present embodiment, a control input port of the audio source controlling control is connected to a control input port of the audio source placeholder control, and an audio output port of the audio source placeholder control is connected to an audio input port of the audio control. The audio source controlling control controls the audio stream input from the audio source placeholder control based on the control parameter.

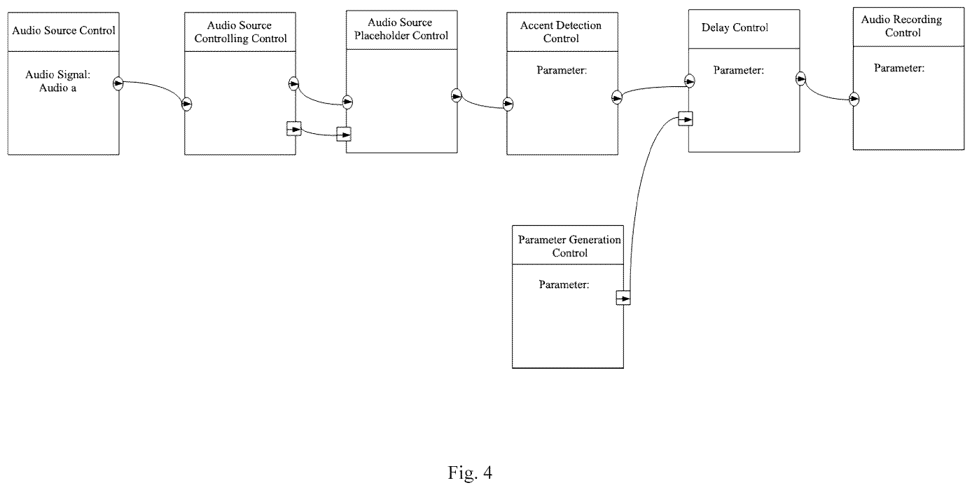

The far-end may be understood as a service end or a network end. Exemplarily, FIG. 4 is an exemplary diagram of an audio effect editing graph provided by the embodiments of the present disclosure. As shown in FIG. 4, on the basis of FIG. 3, an audio source placeholder control is added between the audio source controlling control and the accent detection control, such that the user can input a far-end audio stream through the audio source placeholder control. In the present embodiment, the user can input the far-end audio stream through the audio source placeholder control, thereby enhancing the diversity of audio source.

Optionally, an image effect control is created based on a fourth creation operation triggered by the user; and an input port of the image effect control is connected to an output port of the audio detection control, to enable that the image effect control performs a corresponding effect function according to data output by the audio detection control.

The image effect control is used to add an effect to an image or perform effect processing on an image. An input port of the image effect control is connected to a control output port of the audio detection control, such that the image effect control can perform a corresponding effect function according to data output by the audio detection control. Exemplarily, the image effect control adds a “leaf” falling effect to an image, an input port of the image effect control is connected to a control output port of the pitch detection control, the control output port of the pitch detection control outputs a pitch value, and then the image effect control can determine the speed of leaf falling, the density of leaf falling, etc. according to the pitch value. In the present embodiment, other operation controls may be added between the image effect control and the audio detection control to further calculate the data output by the audio detection control, and input the calculation result to the image effect control, such that the image effect control can perform a corresponding effect function based on the calculation result. In the present embodiment, the manner in which the image effect control performs the effect function based on the data output by the audio detection control is not limited. In the present embodiment, by creating the image effect control in the audio editing interface, the synchronous editing of an image effect and an audio effect can be realized, thereby enhancing the convenience of the effect editing.

The embodiments of the present disclosure includes: creating an audio source control, an audio source controlling control, an audio control, and an audio post-processing control in an audio editing interface based on a first creation operation triggered by a user, in which the audio source control includes at least one of a local audio source control and a microphone audio source control, the audio control includes at least one of an audio effect control and an audio detection control, and the audio post-processing control includes at least one of an audio playback control and an audio recording control; connecting an output port of the audio source control to an input port of the audio source controlling control, connecting an output port of the audio source controlling control to an input port of the audio control, and connecting an output port of the audio control to an input port of the audio post-processing control; and controlling an original audio stream to sequentially flow from the audio source control through the audio source controlling control, the audio control, and the audio post-processing control, to obtain target effect audio. The method for editing an audio effect provided by the embodiments of the present disclosure utilizes a graphical approach to implement audio effect editing, which can reduce the complexity of editing the audio effect.

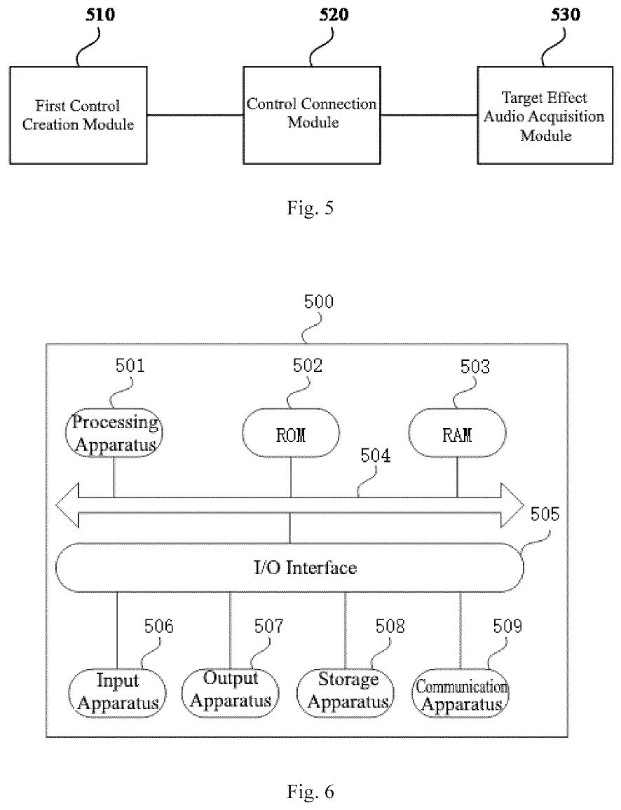

FIG. 5 is a schematic structural diagram of an apparatus for editing an audio effect provided by the embodiments of the present disclosure. As shown in FIG. 5, the apparatus includes:
a first control creation module 510 configured to create an audio source control, an audio source controlling control, an audio control, and an audio post-processing control in an audio editing interface based on a first creation operation triggered by a user, in which the audio source control includes at least one of a local audio source control and a microphone audio source control, the audio control includes at least one of an audio effect control and an audio detection control, and the audio post-processing control includes at least one of an audio playback control and an audio recording control;
a control connection module 520 configured to connect an output port of the audio source control to an input port of the audio source controlling control, connect an output port of the audio source controlling control to an input port of the audio control, and connect an output port of the audio control to an input port of the audio post-processing control; and
a target effect audio acquisition module 530 configured to control an original audio stream to sequentially flow from the audio source control through the audio source controlling control, the audio control, and the audio post-processing control, to obtain target effect audio.

Optionally, the audio source controlling control is provided with a control parameter configuration window for receiving a control parameter input by the user through the control parameter configuration window, to control the original audio stream according to the control parameter.

Optionally, the audio detection control includes a speech recognition control, a speech keyword recognition control, and a target object recognition control.

The speech recognition control is used to identify semantic information of speech in the original audio stream; the speech keyword recognition control is used to identify keywords of the speech in the original audio stream; and the target object recognition control is used to identify a target object of the speech in the original audio stream.

Optionally, at least one of the audio effect control and the audio detection control is provided with a processing parameter configuration window for receiving a processing parameter input by the user through the processing parameter configuration window, to process an input audio stream according to the processing parameter; or the apparatus for editing an audio effect further includes a second control creation module configured to:
create a parameter generation control in the audio editing interface based on a second creation operation triggered by the user, and connect the parameter generation control to at least one of the audio effect control and the audio detection control, in which at least one of the audio effect control and the audio detection control receives a processing parameter generated by the parameter generation control to process an input audio stream according to the processing parameter.

Optionally, the parameter generation control is configured by connecting at least one operation control according to a set operation logic, and an input parameter of the at least one operation control is adjusted by the user.

Optionally, the apparatus for editing an audio effect further includes a third control creation module configured to:
create an audio source placeholder control in the audio editing interface based on a third creation operation triggered by the user; and connect the audio source placeholder control between the audio source controlling control and the audio control, in which the audio source placeholder control is used for inputting a far-end audio stream.

Optionally, the apparatus for editing an audio effect further includes a fourth control creation module configured to:
create an image effect control based on a fourth creation operation triggered by the user; and connect an input port of the image effect control to an output port of the audio detection control, to enable that the image effect control performs a corresponding effect function according to data output by the audio detection control.

The apparatus for editing an audio effect provided by the embodiments of the present disclosure can perform the method for editing an audio effect provided by any embodiment of the present disclosure, and has functional modules and advantageous effects corresponding to the method performed.

It should be noted that in the above-mentioned apparatus, the various units and modules included are merely divided according to functional logic, but are not limited to the above-mentioned division, as long as corresponding functions can be realized; in addition, the specific names of each functional unit are merely taken for facilitating mutual distinction, and are not intended to limit the scope of protection of the embodiments of the present disclosure.

FIG. 6 is a schematic structural diagram of an electronic device provided by the embodiments of the present disclosure. Referring to FIG. 6 below, FIG. 6 illustrates a schematic structural diagram of an electronic device 500 (for example, the terminal device or server in FIG. 6) suitable for implementing the embodiments of the present disclosure. The electronic device in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected through a bus 504. An input/output (I/O) interface 505 is also connected to the bus 504.

Usually, the following apparatuses may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 6 illustrates the electronic device 500 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of the messages or information exchanged between a plurality of apparatuses in the embodiments of the present disclosure are for illustrative purposes only and are not intended to limit the scope of these messages or information.

The electronic device provided by the embodiments of the present disclosure and the method for editing an audio effect provided by the above embodiments belong to the same inventive concept, and technical details not exhaustively described in the present embodiment may be referred to the above embodiments, and the present embodiment has the same beneficial effects as the above embodiments.

The embodiments of the present disclosure further provide a computer-readable storage medium having a computer program stored thereon, which, when executed by a processor, implements the method for editing an audio effect provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:

The above-mentioned computer-readable medium carries one or more programs, and when the one or more programs are executed by the electronic device, the electronic device is caused to: create an audio source control, an audio source controlling control, an audio control, and an audio post-processing control in an audio editing interface based on a first creation operation triggered by a user, in which the audio source control includes at least one of a local audio source control and a microphone audio source control, the audio control includes at least one of an audio effect control and an audio detection control, and the audio post-processing control includes at least one of an audio playback control and an audio recording control; connect an output port of the audio source control to an input port of the audio source controlling control, connect an output port of the audio source controlling control to an input port of the audio control, and connect an output port of the audio control to an input port of the audio post-processing control; and control an original audio stream to sequentially flow from the audio source control through the audio source controlling control, the audio control, and the audio post-processing control, to obtain target effect audio.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

One or more embodiments of the present disclosure provide a method for editing an audio effect, including:
creating an audio source control, an audio source controlling control, an audio control, and an audio post-processing control in an audio editing interface based on a first creation operation triggered by a user, in which the audio source control includes at least one of a local audio source control and a microphone audio source control, the audio control includes at least one of an audio effect control and an audio detection control, and the audio post-processing control includes at least one of an audio playback control and an audio recording control;
connecting an output port of the audio source control to an input port of the audio source controlling control, connecting an output port of the audio source controlling control to an input port of the audio control, and connecting an output port of the audio control to an input port of the audio post-processing control; and
controlling an original audio stream to sequentially flow from the audio source control through the audio source controlling control, the audio control, and the audio post-processing control, to obtain target effect audio.

Further, the audio source controlling control is provided with a control parameter configuration window for receiving a control parameter input by the user through the configuration window, to control the original audio stream according to the control parameter.

Further, the audio detection control includes a speech recognition control, a speech keyword recognition control, and a target object recognition control;
the speech recognition control is used to identify semantic information of speech in the original audio stream; the speech keyword recognition control is used to identify keywords of the speech in the original audio stream; and the target object recognition control is used to identify a target object of the speech in the original audio stream.

Further, at least one of the audio effect control and the audio detection control is provided with a processing parameter configuration window for receiving a processing parameter input by the user through the configuration window, to process an input audio stream according to the processing parameter; or a parameter generation control is created in the audio editing interface based on a second creation operation triggered by the user, and the parameter generation control is connected to at least one of the audio effect control and the audio detection control, in which at least one of the audio effect control and the audio detection control receives a processing parameter generated by the parameter generation control to process an input audio stream according to the processing parameter.

Further, the parameter generation control is configured by connecting at least one operation control according to a set operation logic, and an input parameter of the at least one operation control is adjusted by the user.

Further, the method for editing an audio effect further includes:
creating an audio source placeholder control in the audio editing interface based on a third creation operation triggered by the user; and connecting the audio source placeholder control between the audio source controlling control and the audio control, in which the audio source placeholder control is used for inputting a far-end audio stream.

Further, the method for editing an audio effect further includes: creating an image effect control based on a fourth creation operation triggered by the user; and connecting an input port of the image effect control to an output port of the audio detection control, to enable that the image effect control performs a corresponding effect function according to data output by the audio detection control.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims. Please amend the claims as follows:

1. A method for editing an audio effect, comprising:
creating an audio source control, an audio source controlling control, an audio control, and an audio post-processing control in an audio editing interface based on a first creation operation triggered by a user, wherein the audio source control comprises at least one of a local audio source control and a microphone audio source control, the audio control comprises at least one of an audio effect control and an audio detection control, and the audio post-processing control comprises at least one of an audio playback control and an audio recording control;
connecting an output port of the audio source control to an input port of the audio source controlling control, connecting an output port of the audio source controlling control to an input port of the audio control, and connecting an output port of the audio control to an input port of the audio post-processing control; and
controlling an original audio stream to sequentially flow from the audio source control through the audio source controlling control, the audio control, and the audio post-processing control, to obtain target effect audio.

2. The method for editing an audio effect according to claim 1, wherein the audio source controlling control is provided with a control parameter configuration window for receiving a control parameter input by the user through the control parameter configuration window, to control the original audio stream according to the control parameter.

3. The method for editing an audio effect according to claim 1, wherein the audio detection control comprises a speech recognition control, a speech keyword recognition control, and a target object recognition control;
the speech recognition control is used to identify semantic information of speech in the original audio stream; the speech keyword recognition control is used to identify keywords of the speech in the original audio stream; and the target object recognition control is used to identify a target object of the speech in the original audio stream.

4. The method for editing an audio effect according to any one claim 1, wherein at least one of the audio effect control and the audio detection control is provided with a processing parameter configuration window for receiving a processing parameter input by the user through the processing parameter configuration window, to process an input audio stream according to the processing parameter; or
a parameter generation control is created in the audio editing interface based on a second creation operation triggered by the user, and the parameter generation control is connected to at least one of the audio effect control and the audio detection control, wherein at least one of the audio effect control and the audio detection control receives a processing parameter generated by the parameter generation control to process an input audio stream according to the processing parameter.

5. The method for editing an audio effect according to claim 4, wherein the parameter generation control is configured by connecting at least one operation control according to a set operation logic, wherein an input parameter of the at least one operation control is adjusted by the user.

6. The method for editing an audio effect according to claim 1, further comprising:
creating an audio source placeholder control in the audio editing interface based on a third creation operation triggered by the user; and connecting the audio source placeholder control between the audio source controlling control and the audio control, wherein the audio source placeholder control is used for inputting a far-end audio stream.

7. The method for editing an audio effect according to claim 1, further comprising:
creating an image effect control based on a fourth creation operation triggered by the user; and connecting an input port of the image effect control to an output port of the audio detection control, to enable that the image effect control performs a corresponding effect function according to data output by the audio detection control.

8. (canceled)

9. An electronic device, comprising:
one or more processors; and
a storage apparatus configured to store one or more programs,
wherein when the one or more programs are executed by the one or more processors, the one or more processors implement a method for editing an audio effect, and the method comprises:
creating an audio source control, an audio source controlling control, an audio control, and an audio post-processing control in an audio editing interface based on a first creation operation triggered by a user, wherein the audio source control comprises at least one of a local audio source control and a microphone audio source control, the audio control comprises at least one of an audio effect control and an audio detection control, and the audio post-processing control comprises at least one of an audio playback control and an audio recording control;
connecting an output port of the audio source control to an input port of the audio source controlling control, connecting an output port of the audio source controlling control to an input port of the audio control, and connecting an output port of the audio control to an input port of the audio post-processing control; and
controlling an original audio stream to sequentially flow from the audio source control through the audio source controlling control, the audio control, and the audio post-processing control, to obtain target effect audio.

10. A non-transitory storage medium, comprising computer-executable instructions, wherein the computer-executable instructions, when executed by a computer processor, perform a method for editing an audio effect, and the method comprises:
creating an audio source control, an audio source controlling control, an audio control, and an audio post-processing control in an audio editing interface based on a first creation operation triggered by a user, wherein the audio source control comprises at least one of a local audio source control and a microphone audio source control, the audio control comprises at least one of an audio effect control and an audio detection control, and the audio post-processing control comprises at least one of an audio playback control and an audio recording control;
connecting an output port of the audio source control to an input port of the audio source controlling control, connecting an output port of the audio source controlling control to an input port of the audio control, and connecting an output port of the audio control to an input port of the audio post-processing control; and
controlling an original audio stream to sequentially flow from the audio source control through the audio source controlling control, the audio control, and the audio post-processing control, to obtain target effect audio.

11. The method for editing an audio effect according to claim 2, wherein the audio detection control comprises a speech recognition control, a speech keyword recognition control, and a target object recognition control;
the speech recognition control is used to identify semantic information of speech in the original audio stream; the speech keyword recognition control is used to identify keywords of the speech in the original audio stream; and the target object recognition control is used to identify a target object of the speech in the original audio stream.

12. The method for editing an audio effect according to claim 2, wherein at least one of the audio effect control and the audio detection control is provided with a processing parameter configuration window for receiving a processing parameter input by the user through the processing parameter configuration window, to process an input audio stream according to the processing parameter; or
a parameter generation control is created in the audio editing interface based on a second creation operation triggered by the user, and the parameter generation control is connected to at least one of the audio effect control and the audio detection control, wherein at least one of the audio effect control and the audio detection control receives a processing parameter generated by the parameter generation control to process an input audio stream according to the processing parameter.

13. The method for editing an audio effect according to claim 3, wherein at least one of the audio effect control and the audio detection control is provided with a processing parameter configuration window for receiving a processing parameter input by the user through the processing parameter configuration window, to process an input audio stream according to the processing parameter; or
a parameter generation control is created in the audio editing interface based on a second creation operation triggered by the user, and the parameter generation control is connected to at least one of the audio effect control and the audio detection control, wherein at least one of the audio effect control and the audio detection control receives a processing parameter generated by the parameter generation control to process an input audio stream according to the processing parameter.

14. The method for editing an audio effect according to claim 11, wherein at least one of the audio effect control and the audio detection control is provided with a processing parameter configuration window for receiving a processing parameter input by the user through the processing parameter configuration window, to process an input audio stream according to the processing parameter; or
a parameter generation control is created in the audio editing interface based on a second creation operation triggered by the user, and the parameter generation control is connected to at least one of the audio effect control and the audio detection control, wherein at least one of the audio effect control and the audio detection control receives a processing parameter generated by the parameter generation control to process an input audio stream according to the processing parameter.

15. The electronic device according to claim 9, wherein the audio source controlling control is provided with a control parameter configuration window for receiving a control parameter input by the user through the control parameter configuration window, to control the original audio stream according to the control parameter.

16. The electronic device according to claim 9, wherein the audio detection control comprises a speech recognition control, a speech keyword recognition control, and a target object recognition control;
the speech recognition control is used to identify semantic information of speech in the original audio stream; the speech keyword recognition control is used to identify keywords of the speech in the original audio stream; and the target object recognition control is used to identify a target object of the speech in the original audio stream.

17. The electronic device according to claim 9, wherein at least one of the audio effect control and the audio detection control is provided with a processing parameter configuration window for receiving a processing parameter input by the user through the processing parameter configuration window, to process an input audio stream according to the processing parameter; or
a parameter generation control is created in the audio editing interface based on a second creation operation triggered by the user, and the parameter generation control is connected to at least one of the audio effect control and the audio detection control, wherein at least one of the audio effect control and the audio detection control receives a processing parameter generated by the parameter generation control to process an input audio stream according to the processing parameter.

18. The electronic device according to claim 17, wherein the parameter generation control is configured by connecting at least one operation control according to a set operation logic, wherein an input parameter of the at least one operation control is adjusted by the user.

19. The electronic device according to claim 9, wherein the method further comprises:
creating an audio source placeholder control in the audio editing interface based on a third creation operation triggered by the user; and connecting the audio source placeholder control between the audio source controlling control and the audio control, wherein the audio source placeholder control is used for inputting a far-end audio stream.

20. The electronic device according to claim 9, wherein the method further comprises:
creating an image effect control based on a fourth creation operation triggered by the user; and connecting an input port of the image effect control to an output port of the audio detection control, to enable that the image effect control performs a corresponding effect function according to data output by the audio detection control.

21. The non-transitory storage medium according to claim 10, wherein the audio source controlling control is provided with a control parameter configuration window for receiving a control parameter input by the user through the control parameter configuration window, to control the original audio stream according to the control parameter.
